(19) United States
(12) Patent Application Publication
(10) Pub. No.: US 2005/0070636 A1
(43) Pub. Date: Mar. 31, 2005

(54) Incombustible composition, incombustible construction product using incombustible composition, and method of producing incombustible construction product

(75) Inventors: Sang-Hoon Lee, Seoul (KR); Jun-Han Choi, Goyang-Si (KR); Byung-Ick Yoon, Seoul (KR)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Jun-Han CHOI

(21) Appl. No.: 10/950,446

(22) Filed: Sep. 28, 2004

(30) Foreign Application Priority Data
Sep. 29, 2003 (KR) 67416/03

(51) Int. Cl. C08K 3/26; C08K 3/34; C08K 3/40

(52) U.S. Cl. 524/13; 524/443; 524/494; 524/425

(57) ABSTRACT

Disclosed is an incombustible composition, an incombustible construction product using the incombustible composition, and a method of producing the incombustible construction product. The incombustible composition includes 1 to 80 wt % of organic or inorganic fiber, 1 to 80 wt % of fly ash or bottom ash, 1 to 80 wt % of fire-proofing agent, and 1 to 30 wt % of curing fire-retardant resin. Additionally, the method includes mixing components, constituting the incombustible composition, with each other, and pressing the incombustible composition using a high pressure hot press to give a predetermined shape to the incombustible composition. Therefore, the incombustible composition is advantageous in that it is environmentally-friendly because it contains waste materials, and that it has excellent hardness, strength, and water resistance. Other advantages are that its production costs are relatively low, and that it has excellent incombustibility, depending on the contents of the components constituting the incombustible composition.

### BACKGROUND OF THE INVENTION

1. Field of the Invention

The present invention pertains to an incombustible composition, an incombustible construction product using the incombustible composition, and a method of producing the incombustible construction product. More particularly, the present invention relates to an incombustible composition, which is used as construction finishing and interior materials, being safe from fire, to prevent a fire from spreading and to prevent toxic gases from being generated from the construction finishing and interior materials when the construction finishing and interior materials are on fire, an incombustible construction product using the incombustible composition, and a method of producing the incombustible construction product.

2. Description of the Prior Art

Up to now, MDF, plywood, a plaster board, and a wood-wool cement board have been used as representative construction finishing and interior materials in domestic and overseas construction fields.

However, the above construction materials have different physical properties and disadvantages. Accordingly, efforts have been made to develop various fire-retardant materials by properly controlling compositions of the components constituting the construction materials so as to complement the construction materials with each other. However, these efforts are disadvantageous in that the developed fire-retardant materials do not have sufficient physical properties required for construction finishing and interior materials, but have the few desired physical properties, and thus, the use of the fire-retardant materials is applied to limited fields.

In order to better understand the background of the invention, a description will be given of conventional technologies regarding the construction materials, below.

Conventional developments of the fire-retardant materials are mostly focused on coating a fire-retardant pigment on or attaching a fire-retardant film to the MDF or plywood, having no fire-retardancy, while the amount of the fire-retardant pigment or the fire-retardant film is properly controlled, or on attaching a fire-retardant board or an incombustible steel or aluminum plate to the plaster board.

The MDF or plywood is produced by pressing and shaping wood chips using an organic adhesive, and most widely used as the construction finishing and interior materials. However, the MDF or plywood has no fire-retardancy, thereby catching fire easily.

To avoid the above disadvantage, an inorganic adhesive may be used instead of the organic adhesive. However, the MDF or plywood, produced using the inorganic adhesive, is disadvantageous in that layers constituting the MDF or plywood are easily separated from each other and the MDF or plywood is easily damaged, thereby reducing productivity of the MDF or plywood. Additionally, because only the adhesive is made of an inorganic material and the MDF or plywood mostly consists of the combustible wood chips, the MDF or plywood has not sufficient fire-retardant ability (incombustibility, quasi-incombustibility, and fire-retardancy). Hence, it is difficult to commercialize the MDF or plywood using an inorganic adhesive.

As for the plaster board with fire-retardancy, technologies have been developed to attach the fire-retardant board to the plaster board and to attach the incombustible steel or aluminum plate to the plaster board. In this regard, the plaster board is disadvantageous in that a plaster, used as a main component of the plaster board, is relatively heavy, and it is impossible to process the plaster in order to use it as a construction finishing material. However, a technology of a material capable of being used instead of the plaster, has not yet been developed, and thus, the plaster board is still used as construction finishing and interior materials, having the fire-retardancy.

In addition, the wood-wool cement board has been used as the construction finishing and interior materials. The wood-wool cement board is produced by mixing various substances with cement. Examples of the above substances may include relatively light paper particles, perlites, Styrofoam particles, vermiculites, bottom ash, and a mixture thereof, and various additives may be added into the wool-wood cement board in accordance with the use of the wood-wool cement board.

However, the wood-wool cement board is used as construction exterior and ceiling materials rather than the construction finishing and interior materials because the wood-wool cement board has slightly different physical properties from a cement board. In other words, the wood-wool cement board does not serve to radically modify physical properties of the cement board.

Currently, an incombustible construction finishing and interior material is developed, which is produced by pressing and shaping incombustible alumina powder (Al₂O₃). However, the incombustible construction finishing and interior material, including the alumina powder, is more expensive than the MDF or plywood by ten times or more, and thus, it is only applied to special fields but scarcely used in general construction finishing and interior material.

According to the existing Building Standards Act and Fire Services Act in Korea, a finishing and interior material, used in buildings, must be incombustible, quasi-incombustible, or fire-retardant, and the buildings, larger than a predetermined scale, must include fire-proofing sections to prevent the fire from spreading and to shield persons from fire. As well, a fire door, made of a material capable of enduring fire for 30 minutes or one hour must be installed at the fire-proofing sections.

Furthermore, the legally regulated finishing and interior material is evaluated as three categories according to the KS (Korean Standard) F2271 method (a fire-retardant performance test method for construction materials): first-grade fire-retardancy (incombustible materials), second-grade fire-retardancy (quasi-incombustible materials), and third-grade fire-retardancy (fire-retardant materials). Particularly, the fire door is evaluated as the first fire door, enduring fire for one hour, and the second fire door, enduring fire for 30 minutes, according to the KS F2257 method, and it is stated in the Building Standards Act that only the fire door, having performances satisfying the above standards, may be used in the buildings.

The Building Standards Acts of different countries may be slightly different from each other. However, all countries regulate the standards regarding the performances of the construction finishing and interior material, and the Building Standards Act of each country provides that only the materials, having the performances satisfying the above standards, may be applied to the buildings. The reason for this is that the use of the desirable construction finishing and interior material contributes to preventing the fire from spreading and to shielding persons in the buildings from toxic gases occurring due to fire.

However, most of the commercial construction finishing and interior materials insufficiently satisfy the above standards, and do not sufficient physical properties required to be used as the construction finishing and interior material even though they have incombustibility, quasi-incombustibility, or fire-retardancy.

Heretofore, the construction finishing and interior materials with excellent performance have not yet been developed even though many studies have been conducted to develop the construction finishing and interior materials, having incombustibility, quasi-incombustibility, or fire-retardancy. In detail, the MDF or plywood as described above is the most widely used as the construction interior material because the MDF or plywood is inexpensive and lightweight, has excellent processability, and ease of its use in building constructing is ensured. However, the MDF or plywood has poor water-resistance, and no incombustibility, quasi-incombustibility, or fire-retardancy, thereby catching fire easily and accelerating the spread of the fire. Accordingly, the use of the MDF or plywood is limited by the existing Building Standards Act in Korea.

In addition, the plaster board is made of waste chemical gypsum, discharged from a fertilizer plant or a power plant, plaster and the like. The plaster board is inexpensive, and has excellent processability. Further, the ease of use in building constructing is ensured, and the plaster board has incombustibility, quasi-incombustibility, or fire-retardancy. Hence, the plaster board is used as a representative construction finishing and interior material with incombustibility, quasi-incombustibility, or fire-retardancy. However, the plaster board is problematic in that it is very weak against water, easily damaged due to its poor strength, and brings about pollution because a lot of dust is created when it is processed and most of the used plaster board cannot be regenerated. Furthermore, it is difficult to shape the plaster board in various designs and to apply the plaster board to various fields because papers are attached to a surface of the plaster board.

As for the wood-wool cement board, it has excellent strength, water-resistance, and incombustibility, quasi-incombustibility, or fire-retardancy. However, the wood-wool cement board has poor processability, and is relatively heavy and easily damaged. As well, ease of its use in building constructing is not ensured. Therefore, the wood-wool cement board is used as exterior wall materials or surface materials of the buildings, but scarcely used as the construction finishing and interior materials.

### SUMMARY OF THE INVENTION

Accordingly, the present invention has been made keeping in mind the above problems, such as the poor fire-retardancy of conventional construction finishing and interior materials and difficulty in applying the conventional construction finishing and interior materials to various fields, occurring in the prior art, and an object of the present invention is to provide an incombustible composition, which mostly consists of waste materials, and which is environmentally-friendly and inexpensive. In this regard, the incombustible composition has excellent hardness, strength, and water-resistance, and has fire-retardancy depending on contents of the components thereof.

Another object of the present invention is to provide a method of producing an incombustible construction product, having all desirable physical properties, required for construction material, as well as incombustibility, using an incombustible composition.

A further object of the present invention is to provide an incombustible construction product, produced according to the above method, which is used as construction finishing and interior boards, being safe from fire, preventing fires from spreading and preventing toxic gases from being generated from the construction finishing and interior boards when the construction finishing and interior boards are on fire.

In order to accomplish the above object, the present invention provides an incombustible composition, including 1 to 80 wt % of organic or inorganic fiber, 1 to 80 wt % of fly ash or bottom ash, 1 to 80 wt % of fire-proofing agent, and 1 to 30 wt % of curing fire-retardant resin.

Alternatively, the incombustible composition includes 1 to 80 wt % of organic or inorganic fiber, 1 to 80 wt % of fly ash or bottom ash, 1 to 60 wt % of fire-retardant curing agent, 1 to 80 wt % of fire-proofing agent, and 1 to 30 wt % of curing fire-retardant resin.

In order to accomplish the above object, the present invention provides a method of producing an incombustible construction product, which includes mixing 1 to 80 wt % of organic or inorganic fiber, 1 to 80 wt % of fly ash or bottom ash, 1 to 80 wt % of fire-proofing agent, and 1 to 30 wt % of curing fire-retardant resin to produce the incombustible composition, and pressing the incombustible composition using a high pressure hot press to give a predetermined shape to the incombustible composition.

Alternatively, the method includes mixing a fly ash or a bottom ash and a fire-proofing agent with each other; spraying a fire-retardant curing agent onto a mixture, and adding an organic or inorganic fiber into the mixture, containing the fire-retardant curing agent; extruding the resulting mixture using an extrusion system, drying the extruded mixture in a drying system, and shattering the dried mixture into particles with a predetermined size using a shattering device; and adding a curing fire-retardant resin and the fire-proofing agent to the particles to form a paste, and pressing the paste using a high pressure hot press to give a predetermined shape to the paste.

In order to accomplish the above object, the present invention provides an incombustible construction product, produced according to such method, which is applied to a fire door, an incombustible board, or a fire-resisting board.

### DETAILED DESCRIPTION OF THE INVENTION

An incombustible composition according to the present invention includes 1 to 80 wt % of organic or inorganic fiber (a), 1 to 80 wt % of fly ash or bottom ash (b), 1 to 80 wt % of fire-proofing agent (c), and 1 to 30 wt % of curing fire-retardant resin (d). In this regard, this incombustible composition is produced according to a dry compression shaping process.

Alternatively, the incombustible composition according to the present invention may include 1 to 80 wt % of organic or inorganic fiber (a), 1 to 80 wt % of fly ash or bottom ash (b), 1 to 80 wt % of fire-proofing agent (c), 1 to 30 wt % of curing fire-retardant resin (d), and 1 to 60 wt % of fire-retardant curing agent (e). At this time, this incombustible composition is produced according to a wet and dry compression shaping process.

In addition, the incombustible composition of the present invention may further include an incombustible lightening agent (f), an additive, such as a curing acceleration binder, a surfactant, and/or a coloring agent, and water.

According to the present invention, it is preferable that the incombustible composition contains 1 to 80 wt % of organic or inorganic fiber (a). Examples of the organic fiber include paper fragments shattered into fibroid materials, shattered wood fragments, waste fibers, rice bran, vegetable fibers, and a mixture thereof, and the inorganic fiber is exemplified by rock wool, glass wool, basaltic wool, ceramic wool, and a mixture thereof. In this regard, the above exemplified organic or inorganic fibers contain some waste materials.

The organic or inorganic fiber (a) is added into the incombustible composition to enable the incombustible construction product, produced using the incombustible composition, to have similar physical properties to MDF or plywood. Accordingly, the organic or inorganic fiber (a) enables the incombustible construction product to be processed in various sizes, using a small knife (cut knife), and serves to increase the attachment force of the incombustible construction product to screws when the incombustible construction product is attached to a wall.

When the content of the organic or inorganic fiber (a) in the incombustible composition is less than 1 wt %, the incombustible construction product has improved fire-retardancy, but poor processability and attachment force to the screws due to the relatively high hardness thereof. On the other hand, when the content of the organic or inorganic fiber (a) in the incombustible composition is more than 80 wt %, the strength of the incombustible construction product is reduced to lower the dimensional stability of the incombustible construction product.

Additionally, the fly ash or bottom ash (b) is used to secure sufficient surface strength and a smooth surface of the incombustible construction product. At this time, the density, and surface and compression strengths of the incombustible construction product may be controlled in accordance with the content of fly ash or bottom ash (b) in the incombustible composition.

In the present specification, the term “fly ash” means a relatively lightweight ash portion of remaining ash after the burning of coals used as a fuel in a steam power plant, the term “bottom ash” meaning ash portion heavier than fly ash.

Even though fly ash or bottom ash (b) have lighter specific gravity than the cement, fly ash or bottom ash (b) have relatively high specific gravity in comparison with other components constituting of the incombustible construction product. Hence, when the fly ash or bottom ash (b) content of the incombustible construction product is relatively high, it is difficult to accomplish the lightening of the incombustible construction product, but it is possible to obtain a strong incombustible construction product having the improved strength.

In other words, when the content of the fly ash or bottom ash (b) in the incombustible construction product is less than 1 wt %, it is difficult to produce the smooth incombustible construction product having the desired hardness and surface effect. On the other hand, when the content of the fly ash or bottom ash (b) in the incombustible construction product is more than 80 wt %, the incombustible construction product is relatively high in terms of specific gravity and easily damaged by a relatively weak impact, and thus, it is not proper to use as a board or a square timber.

The organic or inorganic fiber (a) constituting the incombustible construction product may be made of combustible materials. Hence, the fire-proofing agent (c), such as calcium carbonate, sodium bicarbonate, sodium carbonate, other carbonates, or a mixture thereof, may be added into the incombustible composition to minimize the combustion of the incombustible construction product or the occurrence of toxic gases when the incombustible construction product is on fire, thereby the incombustible construction product ensures the incombustibility or quasi-incombustibility.

Furthermore, when the incombustible construction product, containing the fire-proofing agent (c), is on fire at a temperature of 500° C. or higher, the fire-proofing agent (c) is decomposed to allow carbon dioxide (CO₂) to flow out of the incombustible construction product, thereby extinguishing the fire. Accordingly, the incombustible construction product, containing the three components, that is, the organic or inorganic fiber (a), the fly ash or bottom ash (b), and the fire-proofing agent (c), is improved in terms of the fire-retardancy because of the fire-proofing agent (c). In other words, the quasi-incombustible construction product is improved to the incombustible construction product, and the fire-retardant construction product is improved to the quasi-incombustible or incombustible construction product.

At this time, it is preferable that the content of the fire-proofing agent (c) in the incombustible composition is 1 to 80 wt %. When the content of the fire-proofing agent (c) in the incombustible composition is less than 1 wt %, the incombustible composition does not secure a sufficient fire-proofing agent effect. On the other hand, when the content of the fire-proofing agent (c) is more than 80 wt %, the strength of the incombustible construction product is reduced.

However, the incombustible composition, containing only the above three components, that is, the organic or inorganic fiber (a), the fly ash or bottom ash (b), and the fire-proofing agent (c), is disadvantageous in that it does not have desirable compression or tensile strengths required for construction material, is readily deformed when the incombustible composition is cured, and cannot be easily attached to various finishing materials even though it has incombustibility.

To avoid the above disadvantages, the curing fire-retardant resin (d), such as a phenol resin, a fire-retardant polyester resin, or a melamine resin, is added into the incombustible composition to enable the incombustible construction product to have desired physical properties, required for construction material, as well as incombustibility.

In this respect, it is preferable that a content of the curing fire-retardant resin (d) in the incombustible composition is 1 to 30 wt %. When the content of the curing fire-retardant resin (d) is less than 1 wt %, it is impossible to conduct the curing of the incombustible composition. On the other hand, when the content of the curing fire-retardant resin (d) is more than 30 wt %, the production costs of the incombustible composition are undesirably increased while the curing efficiency of the incombustible composition is no longer increased.

The incombustible composition, containing the above four components, that is, the organic or inorganic fiber (a), the fly ash or bottom ash (b), the fire-proofing agent (c), and the curing fire-retardant resin (d), is pressed into a desired shape using a high pressure hot press, preferably a high pressure hot press equipped with a high frequency heater, to accomplish the incombustible construction product.

In addition, a fire-retardant curing agent (e), such as sodium silicate, potassium silicate, or a mixture thereof, may be selectively added into the incombustible composition in an amount of 1 to 60 wt % to further improve incombustibility of the incombustible composition, containing the organic or inorganic fiber (a). In this regard, strength and processability, or the fire-retardancy of a construction board, produced using the incombustible composition, may be controlled in accordance with the content of the fire-retardant curing agent (e) in the incombustible composition.

When the content of the fire-retardant curing agent (e) in the incombustible composition is less than 1 wt %, other components constituting the incombustible composition are not sufficiently bound to each other to reduce strength and hardness of the incombustible construction product, thereby hindering the incombustible construction product from fulfilling its function. On the other hand, when the content of the fire-retardant curing agent (e) in the incombustible composition is more than 60 wt %, the incombustible construction product may be easily deformed due to a non-uniform surface curing speed distribution thereof.

However, both wet and dry processes must be utilized to produce the incombustible construction product using the fire-retardant curing agent (e). In detail, a wet process is conducted to provide characteristics of the fire-retardant curing agent (e) to the incombustible construction product, and a dry process is then conducted to enable the incombustible construction product to have physical properties required for construction material, in which the curing fire-retardant resin (d), such as the phenol resin, fire-retardant polyester resin, or melamine resin, is added into the incombustible construction product, thereby accomplishing the incombustible construction product, simultaneously having fire-retardancy and physical properties required for construction material.

Selectively, the incombustible lightening agent (f) may be added into the incombustible composition to lighten the incombustible construction product. At this time, specific gravities of construction finishing and interior materials may be controlled according to the content of the incombustible lightening agent (f) in the incombustible composition. Examples of the incombustible lightening agent (f) include fine perlite particles, fine vermiculite particles, rockwool wastes, diatomites, zeolites, or a mixture thereof. In this respect, the waste fine perlite particles or waste fine vermiculite particles may be used as the incombustible lightening agent (f).

The content of the incombustible lightening agent (f) in the incombustible construction product may be 1 to 50 wt %. When the content of the incombustible lightening agent (f) in the incombustible composition is less than 1 wt %, the incombustible lightening agent (f) does not affect the specific gravity of the incombustible construction product and not fulfill its function. On the other hand, when the content of the incombustible lightening agent (f) is more than 50 wt %, the surface of the incombustible construction product becomes rough, the strength of the incombustible construction product is reduced, and other components constituting the incombustible composition are not uniformly mixed with each other, leading to a non-uniform distribution of the components in the incombustible composition.

Furthermore, 1 to 10 wt % of curing acceleration binder (g) may be selectively added into the incombustible composition to improve the productivity of the incombustible construction product and to minimize shrinkage and deformation of the incombustible construction product when the incombustible construction product is cured. At this time, the curing acceleration binder (g) serves to enable the fire-retardant curing agent (e) to be quickly dried. In this respect, examples of the curing acceleration binder (g) include magnesia, plaster, inorganic or organic acid mixtures, calcium silicate, or a mixture thereof. Further, the curing time of the incombustible construction product may be controlled according to the content of the fire-retardant curing agent (e) in the incombustible composition.

As well, the surfactant (h) may be selectively added into the incombustible composition to improve its adiabatic property, water resistance, and water repellence of the incombustible construction product, and to promote the lightening of the incombustible construction product. In this regard, the surfactant (h) may be exemplified by an alkylbenzene sulfonic acid-based surfactant, having relatively large surface tension, and functions to reduce resistance to water and water-absorptivity of the incombustible construction product, thereby enabling the shape of the incombustible construction product to be maintained in water. Furthermore, the surfactant (h) serves to increase the porosity of the incombustible construction product to form a plurality of air layers in the incombustible construction product. Thereby, the surfactant (h) improves adiabatic property of the incombustible construction product and contributes to lightening the incombustible construction product. At this time, it is preferable that the content of the surfactant (h) in the incombustible composition is 0.1 to 0.3 wt % because the strength of the incombustible construction product may be reduced according to the content of the surfactant (h).

Meanwhile, the components (a) and (b), constituting the incombustible composition, have dark gray colors, and significantly affect the color of the entire incombustible composition. If the color of the incombustible composition is dark gray, the application of the incombustible composition to various colors of construction finishing and interior materials is limited. Accordingly, 1 to 10 wt % of white inorganic coloring agent (i) may be added into the incombustible composition. In this regard, the white inorganic coloring agent (i) is resistant to the fire and conceals well the dark gray color of the incombustible composition. Additionally, examples of the white inorganic coloring agent (i) include titanium dioxide (TiO2). In conclusion, the white inorganic coloring agent (i) enables the incombustible composition to have the light gray color, thereby providing ease of surface treatment of the incombustible construction product, such as painting and woodgrain coating of the incombustible construction product.

Particularly, red and yellow inorganic coloring agents (j) may be added into the incombustible composition while being mixed in a predetermined mixing ratio to allow the surface color of the incombustible construction product to vary. At this time, a separate coloring process of the incombustible construction product may be omitted.

As well, the incombustible composition according to the present invention may further contain 1 to 60 wt % of water. In detail, water is further added into the incombustible composition so as to smoothly mix the fire-retardant curing agent with other components in case that the fire-retardant curing agent is mixed with other components constituting the incombustible composition. When an amount of water added into the incombustible composition is less than 1 wt %, the mixing of the fire-retardant curing agent with other components is not sufficiently conducted because the paste is thick. On the other hand, when the content of water in the incombustible composition is more than 60 wt %, the drying time of the paste is undesirably long.

The production of the incombustible composition of the present invention and incombustible construction product, produced using the incombustible composition, are conducted according to a dry compression shaping process, or a wet and dry compression shaping process, including a first wet process and a second dry process.

Hereinafter, a detailed description will be given of the production of the incombustible construction product using the incombustible composition according to the present invention, below. It is to be understood that modifications, regarding the production of the incombustible construction product, will be apparent to those skilled in the art without departing from the spirit of the invention.

Production of a Construction Interior Board According To the Dry Compression Shaping Process

A method of producing the incombustible construction interior board according to the dry compression shaping process includes mixing, shaping and drying steps. The components (a), (b), (c), and (d), stored in a silo equipped with a measuring system, are fed into a mixing compartment to be previously mixed with each other by use of a strong air current generated by a 30 to 50 horsepower compressor installed at a lower portion of the mixing compartment. At this time, the components (f), (g), (h) and/or (i) may be selectively added into the mixing compartment through the silo.

A first mixing step is conducted using a mixer, for example, a low-speed ribbon mixer. At this time, the first mixing step may be selectively conducted according to a kind of construction products. The first mixed components are then mixed with each other using a high-speed shattering mixer equipped with blades while uniformly shattering the components, and then pressed using a press, for example, a high pressure hot press of 500 to 3,000 tons to form boards. The boards thusly formed are layered to a predetermined height and subjected to a spontaneous curing process to accomplish the incombustible construction interior board.

With respect to this, the components, fed into the press, may be pressed while reinforcement meshes (nets), made of a glass fiber, are spread on the upper and lower sides of the press to increase compression and tensile strengths of the construction interior board.

Production of an Incombustible Construction Interior Square Timber According to the Dry Compression Shaping Process

The construction interior square timber with excellent incombustibility may be produced using a mold, corresponding in size to a desired square timber, according to a similar procedure to in the case of the construction interior board. Alternatively, the construction interior board may be properly cut using a saw to produce the square timber with a desired size.

In this regard, aluminum, steel, acryl, or wood may be embedded, as a reinforcing material with a shape of square timber or plate, in the construction interior square timber so as to improve compression and tensile strengths of the construction interior square timber.

Production of the Incombustible Construction Interior Board According to the Wet and Dry Compression Shaping Process

The wet and dry compression shaping process includes a first wet process and second dry process. In the first wet process, the fly ash or bottom ash (b) and the fire-proofing agent (c), having relatively low water-absorptivity, are mixed with each other using a mixer after being weighed by use of a measuring system, and the fire-retardant curing agent (e) is sprayed onto a mixture to produce a uniformly mixed paste. After the organic or inorganic fiber (a), having relatively high water-absorptivity, is added into the paste and uniformly mixed with the paste, a predetermined amount of component (e) and water are added into the resulting paste, as desired.

The wet-kneaded components are transmitted into an extrusion system to be extruded to form noodle-like bodies so as to be quickly dried, and completely dried in a drying device, equipped with a conveyor line or a rotary kiln. The dried components are shattered into particles with a desired size using a shattering device, and then stored in a storage tank until the second dry process is conducted.

Subsequently, the particles, subjected to the first wet process to secure incombustibility and the predetermined degree of hardness, are mixed with the curing fire-retardant resin (d) to increase strength of the incombustible composition, to prevent the incombustible construction interior board from being deformed, and to attach finishing materials to the construction interior board. Further, the component (c) is added into the particles to compensate for insufficient incombustibility of the component (d). Selectively, the components (g), (i), and/or (j) may be further added into the particles. Furthermore, it is necessary to properly control the content of the component (f) so as to enable the construction product to have desired specific gravity because the specific gravity of the incombustible construction product is changed according to the use of the incombustible construction product.

For example, when a construction product, such as an access floor, has a density of 1.1 to 1.2 g/cm², it is not necessary to add the component (f) into the particles to control the specific gravity of the construction product. In the case of a typical construction interior board, it has the density of 0.7 to 0.9 g/cm², and thus, the component (c) must be added into the particles so as to control the specific gravity of the typical construction interior board.

Subsequently, the components, mixed so as to enable the construction interior board to have the desired specific gravity, are pressed using a high pressure hot press (500 to 3,000 tons) at 60 to 200° C. for 1 to 60 min to accomplish the incombustible construction interior board.

If a high pressure hot press with a high frequency heating function is used to press the incombustible composition, the component (d) is quickly cured to significantly reduce pressing time of the incombustible composition.

Incidentally, the components, fed into the press, may be pressed while reinforcement meshes (nets), made of a glass fiber, are spread on the upper and lower sides of the press to increase compression and tensile strengths of the construction interior board.

Production of the Incombustible Construction Interior Square Timber According to the Wet and Dry Compression Shaping Process

The construction interior square timber with excellent incombustibility may be produced according to a similar procedure to in the case of the construction interior board.

In this regard, aluminum, steel, acryl, or wood may be embedded, as a reinforcing material with a shape of square timber or plate, in the construction interior square timber so as to improve compression and tensile strengths of the construction interior square timber.

Meanwhile, the construction product, having excellent incombustibility, of the present invention has various characteristics according to each process. In detail, the construction product, produced according to the dry compression shaping process, has a smooth surface and excellent strength, and is not deformed nor shrunk during the curing process. However, the above construction product according to the dry compression shaping process has poorer fire-retardancy than in the case of the wet and dry compression shaping process.

The construction product according to the present invention, having excellent incombustibility or fire-retardancy, and excellent physical properties, may be usefully applied to the following various fields.

\mathring{1} Wood Fire Door

The fire door, produced using the incombustible board and square timber according to the present invention, has many advantages, such as excellent fire-resisting and fire-proofing functions, excellent processability, and various finishing functions, unlike a conventional steel fire door. Particularly, if the wood fire door according to the present invention is applied to the inner doors of tenement houses, such as apartment houses, the wood fire door functions to prevent a fire from spreading and to shield persons from toxic gases generated by fire when the houses are on fire, thereby securing improved residential environment.

\mathring{2} Fire Wall

The use of the incombustible fire wall, produced according to the present invention, leads to the reduction of the production costs and a load of the fire wall, and the reduction of a thickness of the fire wall (an average thickness of the typical fire wall is 100 m/m), thereby increasing the effective area of the fire wall.

\mathring{3} Fire-Resisting Board

When four sides of a steel member of the fire-resisting board are subjected to a finishing process using the incombustible construction product according to the present invention, the covering of the steel member using the incombustible construction product and the finishing of the fire-resisting board are simultaneously accomplished.

\mathring{4} Incombustible Board

The incombustible board, produced using the incombustible construction product in accordance with the present invention, overcomes the disadvantages of a conventional plaster board, has excellent incombustibility and processability, and is easily regenerated. Accordingly, the above incombustible board is useful as the construction finishing and interior material.

\mathring{5} Board When the incombustible board according to the present invention is applied to a reinforced floor, an access floor, an OA floor, a stair board, a fire wall, a partition wall, a lavatory partition, a wall finishing and interior material, a ceiling finishing and interior material, a built-in furniture, a kitchen table, a desk, a filing cabinet, or a table, the above construction finishing and interior products, including the incombustible board, can have excellent incombustibility and economic efficiency, and is efficiently lightened.

Having generally described this invention, a further understanding can be obtained by reference to examples and comparative examples which are provided herein for the purposes of illustration only and are not intended to be limiting unless otherwise specified.

Physical properties of samples according to the examples and comparative examples are evaluated as follows.
1) Incombustibility, quasi-incombustibility, and fire-retardancy: the samples are evaluated in three categories according to a KS F2271 method (a fire-retardant performance test method for construction materials): first-grade fire-retardancy (incombustible materials), second-grade fire-retardnacy (quasi-incombustible materials), and third-grade fire-retardancy (fire-retardant materials)
2) Specific gravity and density: The specific gravities and densities of the samples are measured according to a KS L5316 method (test method of physical properties of plaster boards)
3) Fire resistance: The fire resistances of the samples are evaluated according to a KS F3507 method (plaster boards)
4) Submergence stability: The submergence stabilities of the samples are evaluated according to the KS F3507 method (plaster boards)

After the construction products were produced according to the dry compression shaping process and the wet and dry compression shaping process, the fire-retardancy and physical properties of the construction products, depending on a kind of the components constituting the construction products, were evaluated, and the results were compared with each other. As for the incombustibility, quasi-incombustibility, or the fire-retardancy of each construction product, which is considered as the most important factor to be accomplished in the present invention, the construction products were evaluated in three categories according to the KS F2271 method: first-grade fire-retardancy (incombustible materials), second-grade fire-retardnacy (quasi-incombustible materials), or third-grade fire-retardancy (fire-retardant materials). In this regards, these evaluations were conducted according to contents of components constituting the construction products and a kind of the construction products, and compared with each other.

Furthermore, a weight per unit area of each construction product was measured, and a weight change of the construction product according to a mixing ratio of the components was measured. Additionally, stability of each construction product against fire was evaluated by use of fire resistance of the construction product.

Particularly, submergence stabilities of the construction products were evaluated because it is required that most of the construction finishing and interior materials have submergence stabilities, and the results were compared with each other.

### EXAMPLES 1 TO 3

Components as described in the following Table 1 were fed into a mixing compartment, and previously mixed with each other for ten minutes using a strong air current generated by a compressor, installed at a lower part of the mixing compartment. At this time, the amount of each component was described in the following Table 1. The main mixing of the components was conducted using a low-speed ribbon mixer, or a high-speed shattering mixer. Subsequently, the mixed components were pressed using a high pressure hot press of 500 tons to form boards each having a thickness of 20 m/m and a size of 500 mm×800 mm. The boards formed were then spontaneously cured for three days to create fire-retardant boards. Physical properties of the fire-retardant boards were evaluated according to the above evaluation methods, and the results are described in the following Table 1.

TABLE 1
Physical properties of the incombustible construction product produced
according to the dry compression shaping process

| | | | | | | | Physical properties of the | | | |
|---|---|---|---|---|---|---|---|---|---|---|
| | Composition (wt %) | | | | | | construction product | | | |
| | ¹(a) | ²(b) | ³(c) | ⁴(d) | ⁵(f) | ⁶Shap. | ⁷Fire | ⁸Sp. | ⁹Subm. | Fire resistance |
| Ex. 1 | 70 | 10 | 10 | 10 | — | Board | 1^{st} | 0.854 | Stable | Incombustible |
| | | | | | | | grade | | | |
| Ex. 2 | 50 | 15 | 15 | 10 | 10 | Board | 1^{st} | 1.061 | Stable | Incombustible |
| | | | | | | | grade | | | |
| Ex. 3 | 30 | 25 | 25 | 10 | 10 | Board | 1^{st} | 1.232 | Stable | Incombustible |
| | | | | | | | grade | | | |

¹(a): component (a), rock wool,
²(b): component (b), fly ash,
³(c): component (c), calcium carbonate,
⁴(d): component (d), phenol resin,
⁵(f): component (f), fine perlite particle,
⁶Shap.: shape of the construction product,
⁷Fire: fire-retardancy,
⁸Sp.: specific gravity/density
⁹Subm.: submergence stability

In the example 1, the weight per unit area of the incombustible board, produced according to the dry compression shaping process, was 0.8 to 1.2, and the fire-retardancy and fire resistance of such an incombustible board were evaluated as the first-grade fire-retardancy (incombustible). Furthermore, the submergence stability of such incombustible board was excellent, and thus, a shape of the incombustible board was maintained in water without being deformed.

### EXAMPLES 4 TO 6

Fly ash and 7 wt % of fire-proofing agent, as described in the following Table 2, were fed through a measuring system into a mixer, and then mixed with each other in the mixer for ten minutes. At this time, 5 wt % of lightening agent was selectively added into the mixer. Subsequently, a portion of fire-retardant curing agent was sprayed onto the mixture to form a uniformly mixed paste. After an organic or an inorganic fiber, having relatively high water-absorptivity, was added into the paste and then mixed with the paste for ten minutes, the remaining fire-retardant curing agent was added into the paste, containing the organic or inorganic fiber, in conjunction with 10 wt % of water. In this respect, the total content of fire-retardant curing agent in the resulting paste was 15 wt %.

The resulting paste was transmitted into an extrusion system to be extruded to form noodle-like bodies, and completely dried in a drying device, equipped with a conveyor line, for 30 min. The dried bodies were shattered into particles using a shattering device.

Subsequently, 10 wt % of curing fire-retardant resin and 3 wt % of calcium carbonate were added into the particles, and the resulting mixture was pressed using a high pressure hot press at about 150° C. for about 30 min to form incombustible boards each having a thickness of 20 m/m and a size of 500 mm×800 mm. At this time, calcium carbonate was added into the particles so as to compensate for insufficient incombustibility of the curing fire-retardant resin. Physical properties of the incombustible products were evaluated according to the above evaluation methods, and the results are described in the following Table 2.

TABLE 2
Physical properties of the incombustible construction product produced
according to the wet and dry compression shaping process

| | | | | | | | | | Physical properties of the | | | |
|---|---|---|---|---|---|---|---|---|---|---|---|---|
| | Composition (wt %) | | | | | | | | construction product | | | |
| | ¹(a) | ²(b) | ³(c) | ⁴(d) | ⁵(e) | ⁶(f) | Water | ⁷Shap. | ⁸Fire | ⁹Sp. | ¹⁰Subm. | ¹¹Fire res. |
| Ex. 4 | 15 | 25 | 10 | 10 | 30 | — | 10 | Square | 1^{st} | 1.25 | Stable | Incombustible |
| | | | | | | | | timber | grade | | | |
| Ex. 5 | 15 | 20 | 10 | 10 | 30 | 5 | 10 | Square | 1^{st} | 1.03 | Stable | Incombustible |
| | | | | | | | | timber | grade | | | |
| Ex. 6 | 20 | 15 | 10 | 10 | 30 | 5 | 10 | Square | 2^{nd} | 0.88 | Stable | Noncombustible |
| | | | | | | | | timber | grade | | | |

¹(a): component (a), shattered waste paper,
²(b): component (b), fly ash,
³(c): component (c), calcium carbonate,
⁴(d): component (d), phenol resin,
⁵(e): component (e), sodium silicate liquid containing 50% of solids,
⁶(f): component (f), fine perlite particle,
⁷Shap.: shape of the construction product,
⁸Fire: fire-retardancy,
⁹Sp.: specific gravity/density
¹⁰Subm.: submergence stability
¹¹Fire res.: fire resistance

From the Table 2, it can be seen that higher content of fly ash in the incombustible composition brings about higher specific gravity of the incombustible construction product, and that higher content of shattered waste paper leads to lower fire-retardancy and fire resistance of the incombustible construction product.

### COMPARATIVE EXAMPLES 1 TO 5

Physical properties of five commercial construction finishing and interior products, including MDF/plywood, a typical plaster board, a fire-proofing plaster board, a slate board, and a wood-wool cement board, were evaluated according to the above methods, and the results are described in the following Table 3.

TABLE 3
Physical properties of commercial construction finishing and interior
products

| | | | | | Physical properties of the construction | | | |
|---|---|---|---|---|---|---|---|---|
| | Composition | | | | product | | | |
| | ¹(a) | ²(b) | ³(c) | Product | ⁴Fire | ⁵Sp. | ⁶Subm. | ⁷Fire res. |
| Co. Ex. 1 | Wood | Adhesive | Water- | MDF/plywood | None | 0.7˜0.8 | Unstable | Combustible |
| | chip | | repellent | | | | | |
| | | | material | | | | | |
| Co. Ex. 2 | Waste | — | Paper | Typical | 2^{nd} | 0.7˜0.9 | Damaged | Noncombustible |
| | plaster | | pasteboard | plaster | grade | | | |
| | | | | board | | | | |
| Co. Ex. 3 | Waste | Glass | Paper | Fire- | 1^{st} | 0.8˜1.0 | Damaged | Incombustible |
| | plaster | fiber | pasteboard | proofing | grade | | | |
| | | | | plaster | | | | |
| | | | | board | | | | |
| Co. Ex. 4 | Cement | Asbestos | Stone | Slate board | 1^{st} | 1.2˜1.4 | Stable | Incombustible |
| | | | powder | | grade | | | |
| Co. Ex. 5 | Cement | Waste | Plaster | Wood-wool | 1^{st} | 1.0˜1.2 | Stable | Incombustible |
| | | paper | | cement | grade | | | |
| | | | | board | | | | |

¹(a): component (a),
²(b): component (b),
³(c): component (c),
⁴Fire: fire-retardancy,
⁵Sp.: specific gravity/density
⁶Subm.: submergence stability
⁷Fire res.: fire resistance

From the Table 3, it can be seen that the commercial construction finishing and interior products have no fire-retardancy, second grade fire-retardancy, first grade fire-retardancy, first grade fire-retardancy, and first grade fire-retardancy for comparative examples 1 (MDF/plywood), 2 (typical plaster board), 3 (fire-proofing plaster board), 4 (slate board), and 5 (wood-wool cement board), respectively. Accordingly, the typical and fire-proofing plaster boards have no problems in securing fire-safety, and the slate board and wood-wool cement board are most preferable to be used as a fire-proofing material.

As shown in the Table 3, the products according the comparative examples 4 and 5 each have the best incombustibility. However, each of them have a poor weight per unit area, and thus, they are problematic in terms of making them lighter. Additionally, the plaster boards each have the poorest submergence stability.

As results, MDF or plywood, widely used as the construction finishing and interior material, has no fire-retardancy, and thus, it is not suitable to be used as the construction material in consideration of the Building Standards Act and the Fire Services Act. Further, the use of the plaster board is limited according to uses and positions of buildings. As for the slate board and wood-wool cement board, they have a much higher weight per unit area than MDF and the plaster board, thereby the ease of use in building constructing cannot be ensured.

Meanwhile, when the examples are compared to the comparative examples, the boards according to the examples 2 and 3 as described in the Table 1 each have the first-grade fire-retardancy, like the slate board and wood-wool cement board according to the comparative examples 4 and 5 as described in the Table 3. As well, the boards are incombustible in terms of fire resistance. Furthermore, the weights per unit area of the boards according to the examples 2 and 3 are 1.0 to 1.2, which are similar to those (1.0 to 1.4) of the slate board and wood-wool cement board according to the comparative examples 4 and 5.

As described above, the present invention provides an incombustible composition used to produce an incombustible/quasi-incombustible/fire-retardant board or square timber. In this regard, 1 to 70 wt % of the incombustible composition may be made of a waste material. Accordingly, the incombustible composition of the present invention is advantageous in that the production costs are reduced, and that it is useful as a construction finishing and interior material because no fire and toxic gases occur when the board or square timber is on fire.

Other advantages are that the incombustible composition has excellent processability (saw processing, screwing, planing, attachment of patterned wood and film, coating, and the like), and that an incombustible construction product, produced using the incombustible composition, has excellent strength and water resistance. In addition, the incombustible construction product is not easily deformed, and can so be applied to fields, to which woods or boards are applied, while having incombustibility, thereby being applied to construction interior/exterior materials. In case that the incombustible construction product is applied to a construction board, the incombustible construction board serves to prevent a fire from spreading and to shield persons from toxic gases generated by fire when the incombustible construction board is on fire, thereby providing a safer environment.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. An incombustible composition, comprising 1 to 80 wt % of organic or inorganic fiber, 1 to 80 wt % of fly ash or bottom ash, 1 to 80 wt % of fire-proofing agent, and 1 to 30 wt % of curing fire-retardant resin.

2. An incombustible composition, further comprising 1 to 60 wt % of fire-retardant curing agent.

3. The incombustible composition as set forth in claim 1, wherein the organic fiber is paper fragments shattered into fibroid materials, shattered wood fragments, waste fibers, rice bran, vegetable fibers, or a mixture thereof, and the inorganic fiber is rock wool, glass wool, basaltic wool, ceramic wool, or a mixture thereof.

4. The incombustible composition as set forth in claim 2, wherein the fire-retardant curing agent is sodium silicate, potassium silicate, or a mixture thereof.

5. The incombustible composition as set forth in claim 1, wherein the fire-proofing agent is calcium carbonate, sodium bicarbonate, sodium carbonate, other carbonates, or a mixture thereof.

6. The incombustible composition as set forth in claim 1, wherein the curing fire-retardant resin is a phenol resin, a fire-retardant polyester resin, or a melamine resin.

7. The incombustible composition as set forth in claim 1, further comprising 1 to 50 wt % of incombustible lightening agent selected from the group consisting of fine perlite particles, fine vermiculite particles, rockwool wastes, diatomites, zeolites, and a mixture thereof.

8. The incombustible composition as set forth in claim 1, further comprising 1 to 10 wt % of additive selected from the group consisting of a curing acceleration binder, a surfactant, an inorganic coloring agent, and a mixture thereof, and/or 1 to 60 wt % of water.

9. The incombustible composition as set forth in claim 8, wherein the curing acceleration binder is magnesia, plaster, inorganic or organic acid mixtures, calcium silicate, or a mixture thereof.

10. The incombustible composition as set forth in claim 8, wherein the inorganic coloring agent is titanium dioxide (TiO2).

11. A method of producing an incombustible construction product, comprising:
mixing 1 to 80 wt % of organic or inorganic fiber, 1 to 80 wt % of fly ash or bottom ash, 1 to 80 wt % of fire-proofing agent, and 1 to 30 wt % of curing fire-retardant resin to produce the incombustible composition according to claim 1; and
pressing the incombustible composition using a high pressure hot press to give a predetermined shape to the incombustible composition.

12. A method of producing an incombustible construction product, comprising:
mixing a fly ash or a bottom ash and a fire-proofing agent in a mixing ratio, corresponding to contents of the fly ash or bottom ash, and fire-proofing agent in the incombustible composition according to claim 2;
spraying a fire-retardant curing agent onto a mixture, and adding an organic or inorganic fiber into the mixture, containing the fire-retardant curing agent;
extruding the resulting mixture using an extrusion system, drying the extruded mixture in a drying system, and shattering the dried mixture into particles of a predetermined size using a shattering device; and
adding a curing fire-retardant resin and the fire-proofing agent to the particles to form a paste, and pressing the paste using a high pressure hot press to give a predetermined shape to the paste.

13. The method as set forth in claim 11, wherein the incombustible construction product is a construction board or a construction square timber.

14. The method as set forth in claim 13, further comprising adding meshes, made of a glass fiber, to the incombustible construction product to reinforce the incombustible construction product in case that the incombustible construction product is the construction board.

15. The method as set forth in claim 13, further comprising embedding a square timber or plate shape of aluminum, steel, acryl, or wood, acting as a reinforcing material, into the incombustible construction product to reinforce the incombustible construction product in case that the incombustible construction product is the construction square timber.

16. The method as set forth in claim 12, further comprising adding the fire-retardant curing agent and water into the mixture, containing the organic or inorganic fiber, after the adding of organic or inorganic fiber.

17. The method as set forth in claim 11, wherein an incombustible lightening agent is further added, according to a specific gravity of the incombustible construction product, into the paste in the pressing of the paste.

18. An incombustible construction product produced according to the method of claim 11.

19. The incombustible construction product as set forth in claim 18, comprising a board and/or a square timber for a fire door, an incombustible board, or a fire-resisting board.

20. The incombustible construction product as set forth in claim 18, comprising a board, constituting a reinforced floor, an access floor, an OA floor, a stair board, a fire wall, a partition wall, a lavatory partition, a wall finishing and interior material, a ceiling finishing and interior material, a built-in furniture, a kitchen table, a desk, a filing cabinet, or a table.
